(19) United States
(12) Patent Application Publication
(10) Pub. No.: US 2021/0339657 A1
(43) Pub. Date: Nov. 4, 2021

(54) REACTIVE AND DISSIPATIVE RECLINER SYSTEM FOR A VEHICLE SEAT

(71) Applicant: Faurecia Sièges d'Automobile, Nanterre (FR)

(72) Inventors: Semir HAMMADI, SAULX LES CHARTREUX (FR); Matthieu DEBRAY, SAINT MICHEL SUR ORGE (FR); Fabrice CAMUS, PARAY VIEILLE POSTE (FR); Roland FAURE, ETAMPES (FR)

(21) Appl. No.: 17/217,717

(22) Filed: Mar. 30, 2021

(30) Foreign Application Priority Data
Mar. 31, 2020 (FR) FR 20 03219

(51) Int. Cl. B60N 2/20; B60N 2/22

(52) U.S. Cl. CPC B60N 2/20; B60N 2/2227

(57) ABSTRACT

A vehicle seat that includes: a cushion; a backrest; an articulation having a first flange fixed to the cushion and a second flange fixed to the backrest, the second flange being mounted so as to be able to rotate with respect to the first flange; a device for straightening the backrest interdependently rotating with the second flange and defining a straightening slot comprising a first portion separated from a second portion by a bridge; and a pin integral with the backrest, extending into the first portion of the straightening slot. When an impact torque greater than a predetermined torque is applied to the backrest, the pin breaches the bridge and then moves freely in the second portion.

### TECHNICAL FIELD

The present invention relates to a vehicle seat of the type comprising a seat and a backrest.

### BACKGROUND

In the event of an impact, in particular a frontal impact, of the vehicle, the force exerted on the seat may be such as to cause a violent compression of seat occupant's thorax against a seatbelt, for example, in particular when the backrest is placed in an inclined position. It may therefore be advantageous to protect the occupant in the event of an impact by returning him/her to a raised position in which the risk of injury is reduced.

For this purpose, provision of a vehicle seat recliner system in case of impact is known. Such a recliner system allows the backrest to be straightened upon impact. This seat recliner system generally includes impact detection sensors and an active mechanical system for straightening the seat in case of impact detection.

Nevertheless, such a recliner system is generally a complex system that is added to the seat, which increases its size and makes its structure heavier. In addition, such a system is subject to the efficiency of the impact detection and the efficiency of the active mechanical straightening elements.

### SUMMARY

One of the objects of the invention is therefore to propose a simple, reliable and space-saving system that reduces the risks incurred by the occupant in the event of an impact, particularly when the backrest of the seat is in an inclined position.

To this end, the invention relates to a vehicle seat of the type further comprising:
a cushion,
a backrest,
an articulation comprising a first flange fixed to the cushion and a second flange fixed to the backrest, the second flange being mounted rotatable about an axis with respect to the first flange by means of a hinge mechanism,
the hinge mechanism being movable between a first configuration in which it enables the backrest to be unlocked and/or rotated with respect to the cushion and a second configuration in which it allows the backrest to be blocked with respect to the cushion,
the hinge mechanism being movable between the first and second configurations via a control element actuatable by an occupant of the seat,
a straightening device for straightening the backrest interdependently rotating with the second flange, the straightening device being for example made in a single piece with the second flange, the straightening device defining a straightening slot, the straightening slot comprising a first portion separated from a second portion by a bridge,
a pin integral with the backrest, the pin extending into the first portion of the straightening slot and being disposed in contact with the edges of the first portion and the bridge, such that, under normal use conditions, the pin ensures the attachment between the backrest and the second flange via the straightening device, the rotation of the second flange about the axis going hand in hand with the rotation of the backrest,
the seat being such that, when the locking mechanism is in its second configuration and when an impact torque greater than a predetermined torque is applied to the backrest, the pin breaches the bridge and then moves freely in the second portion of the straightening slot, which makes the rotation of the backrest free with respect to the straightening device and the second flange.

Thus, when the backrest of the seat is in an inclined position, for example, and in the event of an impact causing the application of an impact torque exceeding a certain threshold on the seat, the backrest straightening device is suitable for enabling the backrest to move from the inclined position to the raised position by the sole mechanical action of the impact itself. In this way, in the raised position, the force applied to the seat occupant's torso is reduced and the risks of injury to the thorax and shoulders are reduced.

According to other embodiments of the invention, the seat may include any of the following features considered alone or according to all technically possible combinations:
when the locking mechanism is in its second configuration and when an impact torque greater than a predetermined torque is applied to the backrest, this makes the rotation of the backrest about the axis relatively to the second flange free,
the backrest is rotatable with respect to the cushion about the axis between a raised position in which the seat is able to receive a seated occupant in an upright position, and at least one inclined position, in which the seat is able to receive an occupant in a semi-recumbent or recumbent position,
   the backrest forming a first angle with an elevation direction in the raised position and the backrest forming a second angle with the elevation direction in the inclined position, the second angle being greater than the first angle;
the hinge mechanism comprises a blocking element movable between a blocking position in which the second flange is rotationally blocked and a unblocking position in which the second flange is rotatable about the axis,
   the seat being such that, under normal conditions of use of the seat, when the blocking element is in its unblocking position, the rotation of the second flange about the axis causes the rotation of the straightening device, which causes the movement of the pin so that the backrest is moved between the raised position and the inclined position,
   the seat further being such that when an impact torque greater than a predetermined torque is applied to the backrest, and when the blocking element is in its blocking position, the pin breaches the bridge and then moves freely into the second portion of the straightening slot, causing the backrest to move relative to the straightening device from the inclined position to the raised position;
the seat further comprises an abutment element connected to the cushion and defining a slideway, the straightening slot extending at least partially opposite the slideway, the pin further extending in the slideway and moving in the slideway when the backrest is moved between its raised position and its inclined position;
the slideway extends between a first front end and a first rear end, the pin abutting said first front end in an extreme raised position and the first rear end in an extreme inclined position;
when the locking mechanism is in its second configuration and an impact torque is applied to the backrest, the pin moves in the straightening slot from a second rear end of the straightening slot to the first front end of the slideway;
the slideway and the straightening slot extend along an arc of a circle having the axis as its center;
the slideway limits the movement of the pin of the backrest during rotation of the backrest relative to the cushion;
the seat further comprises an actuator for actuating the second flange, the actuator driving the second flange substantially in rotation about the axis relatively to the first flange;
the straightening slot comprises a dissipation portion, the width of the dissipation portion being less than a dimension of the pin, the width of the dissipation portion and the dimension of the pin being taken in the direction perpendicular to the direction of movement of the pin in the straightening slot
   the pin expanding the width of the dissipation portion as it moves through the straightening slot;
the straightening device comprises a body,
   the body interdependently rotating with the second flange and defining the straightening slot of the straightening device, the bridge being integral with the body;
the pin is blocked between the bridge and an end of the straightening slot under normal use conditions of the seat; and
the first portion of the straightening slot fits the shape of the section of the pin extending into the straightening slot.

### BRIEF DESCRIPTION OF THE DRAWINGS

Other aspects and advantages of the invention will become apparent from the following description, given by way of example and made with reference to the appended drawings, in which:

FIG. 1 is a schematic representation of a part of the vehicle seat according to an embodiment of the invention in a side view under normal use conditions, with the backrest in a raised position,

FIG. 2 is a schematic representation of a part of the seat of FIG. 1 in a side view under normal use conditions with the backrest in a raised position,

FIG. 3 is a partial schematic representation of a part of the seat of FIG. 1 under normal seat use, with the backrest in an inclined position,

FIG. 4 is a partial schematic representation of a part of the seat of FIG. 1, when an impact torque has been applied to the backrest with the backrest in an inclined position,

FIG. 5 is a schematic perspective representation of a portion of the seat of FIG. 1, showing in particular the backrest straightening device,

FIG. 6 is a schematic representation of the portion of the seat of FIG. 5, the pin having been deliberately omitted,

FIG. 7 is a schematic perspective representation of a portion of the seat of FIG. 1, showing in particular the seat portion of FIG. 5 from another angle, the abutment element and the cushion having been deliberately omitted,

FIG. 8 is a schematic perspective view of the seat portion of FIG. 7, with the gusset shown in its entirety,

FIG. 9 is a schematic perspective representation of a portion of the vehicle seat showing in particular a pin locking element in the first portion, the locking element being in a locked position,

FIG. 10 is a schematic perspective representation of the seat portion of FIG. 9, with the locking element in an unlocked position.

### DETAILED DESCRIPTION

In the description, the elevation direction Z is defined according to the height of a vehicle. This elevation direction Z is vertical, for example, when the vehicle is resting on horizontal ground.

The longitudinal direction X is defined according to the length of the vehicle. This longitudinal direction X is horizontal, for example, when the vehicle is resting on horizontal ground and extends along the usual direction of travel of the vehicle. The terms “front” and “rear” define the directions towards the front of the seat or the rear of the seat respectively, according to the longitudinal direction X and under usual conditions of use of the seat.

The transverse direction Y is defined according to the width of the vehicle. This transverse direction Y is horizontal, for example, when the vehicle is resting on horizontal ground and is orthogonal to the longitudinal direction X.

The conditions of normal use of the seat are conditions in which the vehicle in which the seat is located is used in a conventional manner and has not been subjected to impact, that is, in which, for example, an impact torque greater than a predetermined torque has not been applied to the backrest of said seat. In other words, the normal use conditions correspond to the conditions in which the seat is used outside of an accident phase.

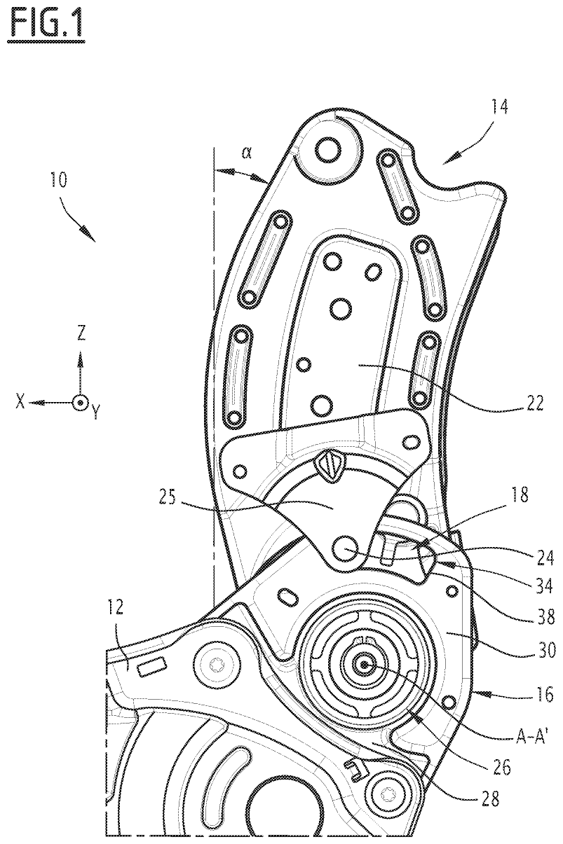

With reference to FIGS. 1 to 4 and 8 to 10, a seat 10 is described, comprising at least a cushion 12, a backrest 14, a gusset 16 and a straightening device 18 for the backrest 14.

The seat 10 is, for example, intended to be mounted in a motor vehicle or in any other type of vehicle, for example a rail vehicle, a marine vehicle or other.

The cushion 12 is standard and will not be described further here.

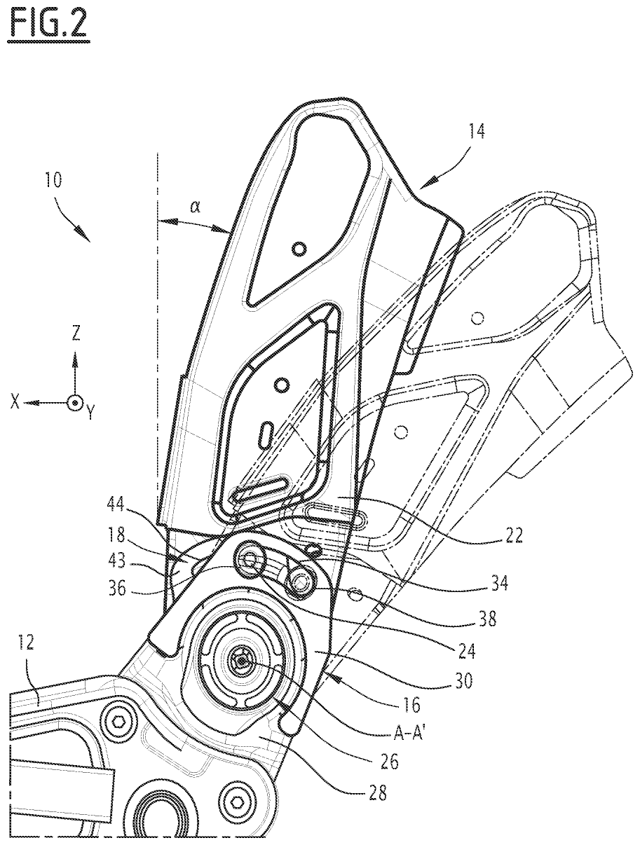

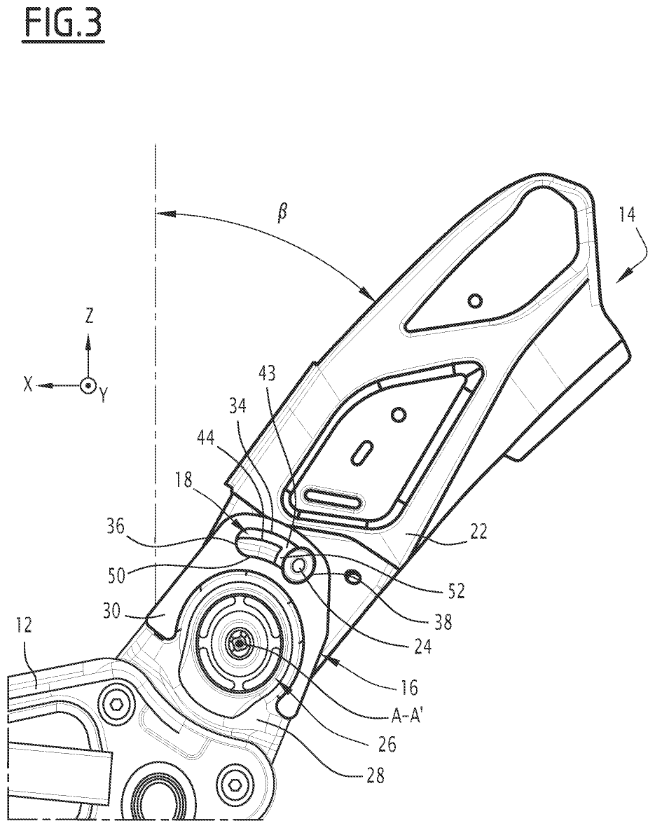

The backrest 14 is rotatably mounted with respect to the cushion 12 about an axis A-A′ between a raised position (visible in FIGS. 1 and 2), in which the backrest forms a first angle α with a direction of elevation Z, and at least one inclined position (visible in FIG. 3), in which the backrest forms a second angle β with the direction of elevation Z, the second angle β being larger than the first angle α.

The first and second angles a and β are such that the cushion 12 and backrest 14 define an obtuse angle between them, that is, an angle greater than 90°.

The first angle α is between 15° and 25°, for example.

The second angle β is greater than the first angle a and is between 25° and 50°, for example. In other words, the backrest 14 is further away from the direction of elevation in the inclined position than in the raised position.

In the raised position of the backrest 14, the seat 10 is suitable for receiving an occupant in an upright position.

Thus, in the raised position, the occupant of the seat 10 is seated in the upright position, in which the occupant faces the windshield, for example, and can observe the environment outside the vehicle.

According to one embodiment, the occupant of the seat 10 may place the backrest 14 in a plurality of inclined positions. The inclined position is, for example, a position also referred to as the relax position, in which the seat occupant can relax. In the inclined position, the seat 10 is thus capable of accommodating an occupant in a semi-recumbent or recumbent position. In particular, in an extreme inclined position of the backrest 14, the occupant of the seat 10 is seated in a recumbent position in which the occupant can relax as if using a sleeper.

For any vehicle type, an occupant of the seat 10 who is not the driver of said vehicle may adjust his/her seat 10 to the raised or inclined position as desired. In the context of an autonomous vehicle, in which the intervention of a driver is limited or non-existent, the raised position corresponds to a manual driving configuration for a driver's seat 10, for example, and the inclined position corresponds to an automatic driving configuration, for example, requiring no intervention by the driver.

The backrest 14 comprises two flanks 22 on each lateral side of the backrest 14 along the transverse direction Y. Each flank 22 extends substantially in a plane comprising the elevation direction Z and the longitudinal direction X. The flank 22 comprises at least one pin 24 extending outwardly from the flank 22. The pin 24 extends outwardly from the flank 22 along the transverse direction Y, for example. The pin 24 is integral with the backrest 14, for example. In a variant, the pin 24 is an attachment fixed to the backrest 14.

According to the embodiment illustrated in FIGS. 1 to 10, the pin 24 has a cylindrical shape, the axis of the cylinder extending along the transverse direction Y. The pin 24 then has a diameter, taken in a plane perpendicular to the transverse direction Y.

According to a variant of this embodiment, the pin 24 has a shape different from the cylindrical shape.

According to an embodiment not shown, the backrest 14 comprises two pins 24, a first pin 24 extending from a first flank 22 of the backrest 14, a second pin 24 extending from a second flank 22 of the backrest 14.

With reference to FIG. 1, the pin 24 is further secured to the backrest 14 by a reinforcing element 25.

The reinforcing element 25 is fixed to the flank 22 of the backrest 14 by at least one fastening element. The fastening element is a screw or a rivet, for example.

The pin 24 is, for example, an attachment fixed to the reinforcing element 25. In a variant, the pin 24 is integral with the reinforcing element 25.

In particular, as illustrated in FIG. 1, the reinforcing element 25 is fixed to the flank 22 of the backrest 14 by at least two fastening elements.

The reinforcing element 25 is an insert attached to the backrest 14, for example. In a variant, the reinforcing element 25 is integral with the backrest 14.

The reinforcing element 25 is deliberately omitted in FIGS. 2 to 6, 9 and 10, for reasons of legibility.

The backrest 14 is rotatably mounted on the cushion 12 via the gusset 16, and the straightening device 18 for example, under normal use of the seat 10.

The gusset 16 comprises an articulation 26, a lower mounting bracket 28, an abutment element 30 of the backrest 14.

The gusset 16 is attached to the cushion 12 by the lower mounting bracket 28. The gusset 16 is, for example, attached to the cushion 12 by at least one fastening element suitable for mounting on the lower mounting bracket 28 of the gusset 16. The fastening element is, for example, a screw or a rivet.

According to an embodiment not shown, the lower mounting bracket 28 is integral with the cushion 12.

With reference to FIGS. 2 to 4, the lower mounting bracket 28 is an attachment to the abutment element 30.

According to a variant illustrated in FIGS. 1 and 8 to 10, the lower mounting bracket 28 is integral with the abutment element 30.

The backrest 14 is rotatably mounted on the cushion 12 via the articulation 26.

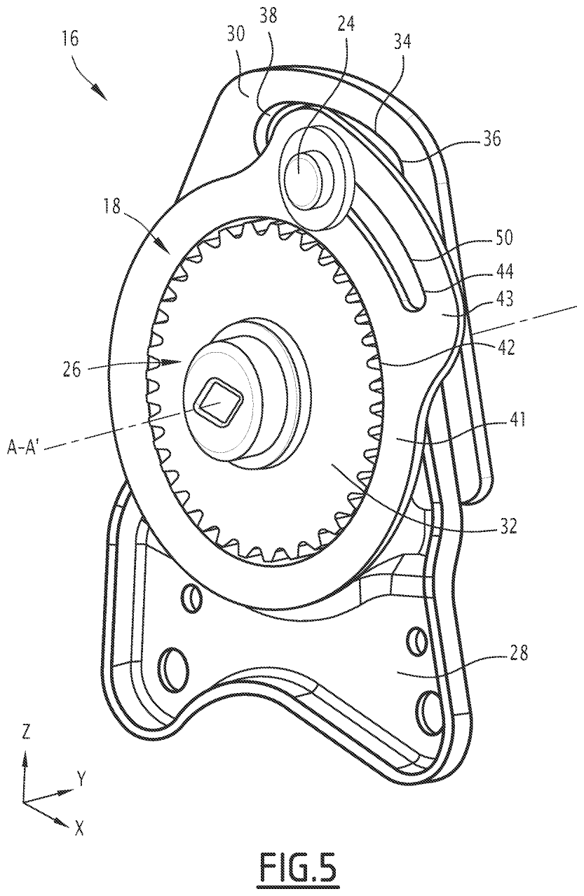

With reference to FIGS. 5 to 8, the articulation 26 comprises a first flange 31 fixed to the cushion 12, a hinge mechanism and a second flange 32 rotatably mounted with respect to the first flange 31 about the axis A-A′ via the hinge mechanism.

The hinge mechanism is movable between a first configuration in which it allows the backrest 14 to be unlocked and/or rotated with respect to the cushion 12 and a second configuration in which it allows the backrest 14 to be blocked with respect to the cushion 12.

Such articulations are known in the prior art. The articulation 26 is an articulation with a grain type locking/unlocking mechanism, for example, or an articulation with a drive mechanism such as epicyclic type mechanisms.

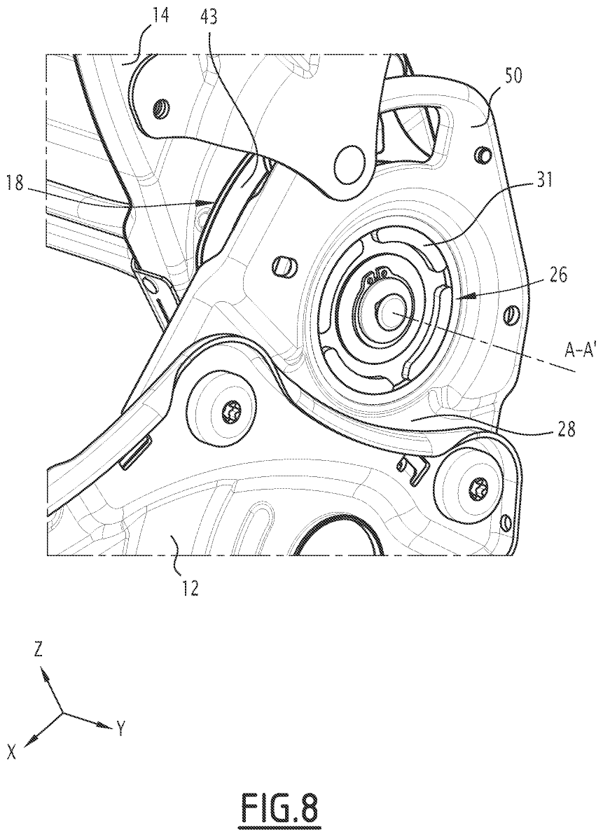

The first flange 31 is, for example, as shown in FIG. 8, attached to the cushion 12 via the mounting bracket 28. The first flange 31 is attached to the lower mounting bracket 28 in particular, for example.

The second flange 32 is attached to the backrest 14, for example, via the straightening device 18 under normal use of the seat 10, as will be described below. The second flange 32 and the straightening device 18 are made in one piece, for example. According to one variant, the second flange 32 is an insert attached to the straightening device 18.

The second flange 32 is thus mounted so that it can rotate with respect to the cushion 12 about the axis A-A′. In particular, the backrest 14 is mounted so as to be rotatable with respect to the cushion 12 about the axis A-A′ by means of the second flange 32 under normal conditions of use of the seat 10.

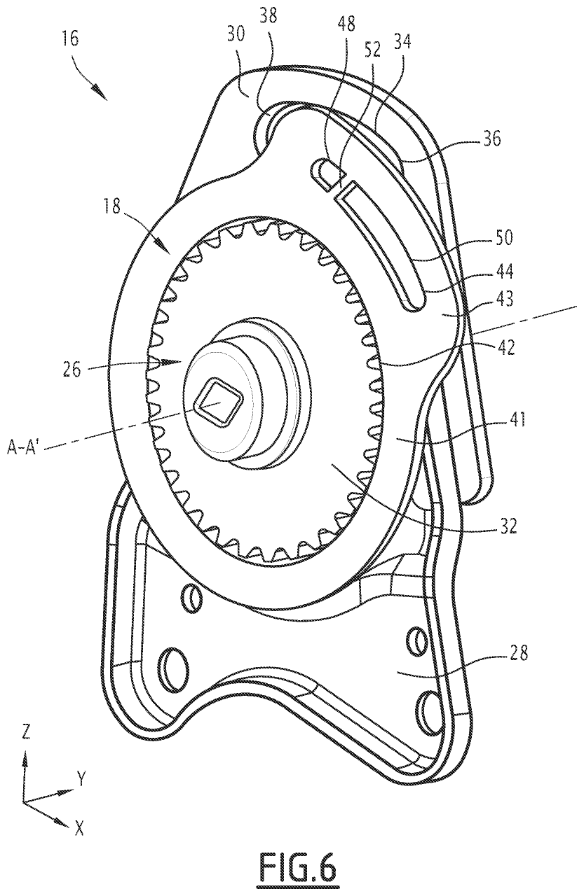

With reference to FIGS. 5 and 6, the second flange 32 has a circular section in the plane formed by the longitudinal direction X and the elevation direction Z.

According to one variant, the gusset 16 further comprises an actuator (not shown). The actuator of the gusset 16 is arranged, when actuated, to cause the second flange 32 to rotate in either direction about the axis A-A′ relative to the first flange 31. The actuator is an electric motor, for example.

The hinge mechanism of the articulation 26 comprises a blocking element movable between a blocking position in which the second flange 32 is rotationally blocked and a unblocking position in which the second flange 32 is rotatable about the axis A-A′.

When the hinge mechanism is in its first configuration, the blocking element is in its unblocking position. When the hinge mechanism is in its second configuration, the blocking element is in its blocking position.

The gusset 16 further comprises a control element (not shown) controlling the hinge mechanism. The control element is movable between an actuating position in which the hinge mechanism is in its first configuration and in which the user can rotate the backrest 14 in either direction and a rest position in which the hinge mechanism is in its second configuration.

When the articulation 26 is a hinge of the type including a grain-type locking/unlocking mechanism, for example, the occupant of the seat 10 moves the control element to an actuating position to unlock the rotation of the backrest 14 relative to the cushion 12. The occupant of the seat 10 can then tilt the backrest 14 to his/her liking.

When the articulation 26 is an articulation of the type including a drive mechanism such as epicyclic type mechanisms, for example, the occupant of the seat 10 moves the control element to its actuating position to unlock the rotation of the backrest 14 relative to the cushion 12, the blocking element otherwise being in the blocking position.

In a variant, when the gusset 16 comprises an actuator, the control element further controls the actuator. When the control element is in the actuated position, the blocking element is in the unblocking position and the actuator causes the second flange 32 to rotate in either direction. In the rest position, the actuator does not cause the second flange 32 to rotate.

The control element of the gusset 16 is arranged to be operated by an occupant of the seat 10. The occupant of the seat 10 can thus control the rotation of the backrest 14 in either direction via the control element. The control element of the gusset 16 is an electric lever or controller, for example, accessible to the occupant of the seat 10 and able to be manipulated by the occupant of the seat 10. Thus, the seat occupant can control the rotational movement of the backrest 14 between the raised position and the inclined position via the control element under normal use of the seat 10.

With reference to FIGS. 5 and 6, the straightening device 18 is located between the gusset 16 and the flank 22 of the backrest 14.

The straightening device 18 comprises a body 41 interdependently rotating with the second flange 32. In particular, the body 41 has a ring shape and defines an opening 42 into which the second flange 32 extends. The body 41 thus extends around the second flange 32. The opening 42 substantially fits the shape of the second flange 32. The body 41 is thus interdependently rotating with the second flange 32 via the edges of the opening 42.

The body 41 defines a straightening slot 44. With reference to FIGS. 5 and 6, the body 41 comprises an extension 43 extending radially with respect to the axis A-A′ and defining the straightening slot 44.

With reference to FIG. 5, the pin 24 of the backrest 14 extends into the straightening slot 44.

The straightening device further comprises a bridge 52 extending into the straightening slot 44.

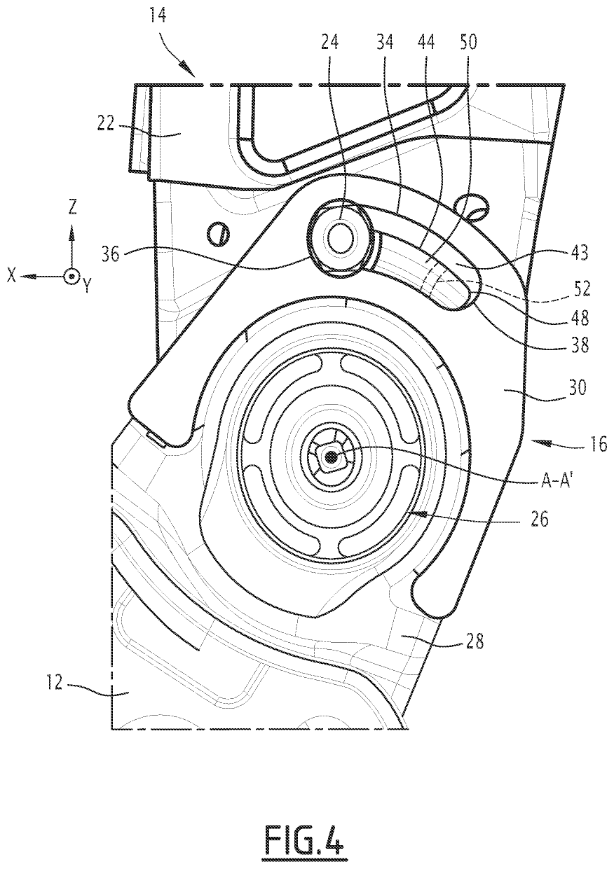

With reference to FIGS. 4 and 6, the straightening slot 44 comprises a first portion 48 and a second portion 50 separated from the first portion 48 by the bridge 52.

The bridge 52 is, for example, formed of a metallic material such as, for example, S420 MC steel.

With reference to FIGS. 1 to 10, the bridge 52 is integral with the body 41.

According to an embodiment not shown, the bridge 52 is an insert attached to the edges of the straightening slot 44.

The bridge 52 is configured to break when an impact force is applied to it.

The impact force is a force greater than a predetermined force. This impact force results from an impact torque applied to the backrest 14 relative to the axis A-A′ upon impact. The impact torque is a torque greater than a predetermined torque, greater than or equal to 200 N.m, advantageously greater than or equal to 250 N.m. Such an impact force is, applied when an impact occurs on the vehicle, for example.

The mechanical resistance of the bridge 52 is such that the bridge 52 resists breaking when a force less than the predetermined force is applied to it.

Under normal use conditions of the seat 10, the pin 24 of the backrest 14 extends into the first portion 48 of the straightening slot 44 and is connected to the edges of the first portion 48 and the bridge 52. In particular, the pin 24 is placed in contact with the edges of the first portion 48 and the bridge 52. The pin 24 is held in the first portion 48 by the edges of the first portion 48 and the bridge 52. Thus, the pin 24 and the straightening device 18 are connected. Thus, the backrest 14 and the straightening device 18 are also connected. In other words, the pin 24 ensures the attachment between the backrest 14 and the second flange 32 via the straightening device 18.

In particular, the pin 24 is blocked between the bridge 52 and one end of the straightening slot 44 under normal use conditions of the seat 10.

In particular, the first portion 48 of the straightening slot 44 conforms to the cross-sectional shape of the pin 24 extending into the straightening slot 44.

Thus, the second flange 32 and the backrest 14 are rotationally fixed under normal use of the seat 10.

In other words, the rotation of the second flange 32 causes rotation of the backrest 14. If the drive element 32 is rotationally blocked by the blocking element, the backrest 14 is also rotationally blocked under normal use of the seat 10.

Thus, when the second flange 32 is rotated, the backrest 14 is rotated relative to the cushion 12 via the straightening device 18. Under normal use of the seat 10, the occupant of the seat 10 can thus adjust the inclination of the backrest 14 relative to the cushion 12 via the control element.

When an impact torque is applied to the backrest 14, for example during a rear impact on the vehicle, the backrest 14 and thus also the pin 24 are driven forward. When the hinge mechanism is in its second configuration, the pin 24 breaches the bridge 52. The second flange 32 and the backrest 14 are then disengaged in rotation.

The pin 24 then moves freely in the second portion 50 of the straightening slot 44, which causes the backrest 14 to move relative to the straightening device 18 from the inclined position to the raised position.

Thus, the breaching of the bridge 52 authorizes the displacement of the pin 24 in the second portion 50 and thus authorizes the displacement of the backrest 14 from the inclined position to the raised position.

In other words, when the pin 24 breaches the bridge 52, the pin 24 then moves freely in the second portion 50 of the straightening slot 44, which frees the backrest 14 to rotate with respect to the straightening device 18 and the second flange 32 from the inclined position to the raised position.

In particular, the backrest 14 rotates from the inclined position to the raised position, without the second flange 32 or the straightening device 18 accompanying the backrest 14 in rotation.

Also, in other words, when the locking mechanism is in its second configuration and when an impact torque greater than a predetermined torque is applied to the backrest 14, this makes the rotation of the backrest 14 about the axis A-A′ relatively to the second flange 32 free. Thus, the rotation of the backrest 14 is performed only about one and the same axis of rotation, here the axis A-A′, regardless of the conditions of use of the seat 10. Thus, even when an impact torque is applied to the backrest 14, the movement of the backrest 14 and thus the movement of the occupant of the seat 10 is performed along the same trajectory as when the seat is used under normal conditions of use of the seat 10. Indeed, the axis of rotation of the backrest 14 with respect to the second flange 32 corresponds to the axis of rotation of the backrest 14 with respect to the seat cushion 12 so that the rotation of the torso of the occupant of the seat 10 is performed around the same axis of rotation A-A′ regardless of the conditions of use. Thus, the rotation movement is adapted to the morphology of the occupant of the seat 10, which is not the case when the rotation axis of the backrest 14 with respect to the second flange 32 does not correspond to the rotation axis of the backrest 14 with respect to the seat 12. Moreover, since the rotational movements are performed around one and the same axis A-A′, this reduces the complexity of the design of the seat 10.

The straightening slot 44 further comprises a dissipation portion (not shown) having a width, taken along a direction perpendicular to the direction of movement of the pin 24.

The width of the dissipation portion is less than a dimension of the pin 24 taken along the direction perpendicular to the direction of movement of the pin 24. In particular, according to the embodiment shown in FIGS. 1 to 10, the width of the dissipation portion is less than the diameter of the pin 24.

For example, the dissipation portion is comprised in the second portion 50 of the straightening slot 44.

According to one variant, the second portion 50 is the dissipation portion.

The dissipation portion is suitable for being deformed by its width expanding as the pin 24 moves through the dissipation portion.

When an impact torque is applied to the backrest 14, the pin 24 moves into the second portion 50 and expands the width of the dissipation portion of the second portion 50. The widening of the width of the dissipation portion at least partially dissipates the impact energy resulting from the impact force due to the impact.

The abutment element 30 extends on each lateral side of the backrest 14 opposite a flank 22 of the backrest 14.

According to an embodiment not shown, the backrest 14 is rotatably mounted on the cushion 12 via two gussets 16, with each abutment element 30 of each gusset 16 extending on each lateral side of the backrest 14 facing a flank 22 of the backrest 14.

The abutment element 30 defines a slideway 34 extending between a first front end 36 and a first rear end 38.

The first front end 36 is, for example, in a front part of the slideway 34 along the longitudinal direction X. The first rear end 38 is, for example, in a rear portion of the slideway 34 along the longitudinal direction X.

The straightening slot 44 extends at least partially opposite the slideway 34.

The pin 24 of the backrest 14 extends from the flank 22 through the straightening slot 44 and into the slideway 34.

When the backrest 14 comprises two pins 24 extending respectively from a first flank 22 and a second flank 22 and the seat comprises two stop elements 30 extending respectively on each lateral side of the backrest 14 opposite each flank 22, each pin 24 of the backrest 14 extends into the slideway 34 of the stop element 30 it faces.

As shown in FIG. 1, the reinforcing element 25 extends from the pin 24 toward the flank 22 of the backrest 14 such that the reinforcing element 25 and the flank 22 extend on opposite sides of the abutment element 30.

The reinforcing element 25 reinforces the connection between the pin 24 and the backrest 14.

Each pin 24 moves in the slideway 34 as the backrest 14 is moved between the raised position and the inclined position. Each pin 24 abuts the first front end 36, for example, in an extreme raised position and abuts the first rear end 38 in an extreme inclined position and under normal use of the seat 10.

The first front end 36 and the first rear end 38 thus constitute abutting ends for the pin 24.

Thus, each slideway 34 limits the movement of the pin 24 between the first front end 36 and the first rear end 38. Each slideway 34 thus also limits the rotational movement of the backrest 14 relative to the cushion 12 between the extreme raised position and the extreme inclined position.

When the backrest is in the inclined position, when impact torque is applied to the backrest 14, such as during a rear impact to the vehicle, the pin 24 moves freely from a rear end of the straightening slot 44 to the first front end 36 of the slideway 34.

When the backrest 14 is in the extreme raised position, when an impact torque is applied to the backrest 14, the pin 24 is already abutting the first front end 36 of the slide 3 and therefore cannot move into the second portion 50 of the straightening slot 44.

Thus, the pin 24 can only move into the second portion 50 of the straightening slot 44 when the backrest 14 is in a position other than the extreme raised position.

In addition, each slideway 34 guides each pin 24 as the backrest 14 rotates relative to the cushion 12.

With reference to FIGS. 1 to 6 and 8 to 10, the slideway 34 extends along an arc of a circle having the axis A-A′ as its center.

The straightening slot 44 extends along the same arc as that of the slideway 34, for example.

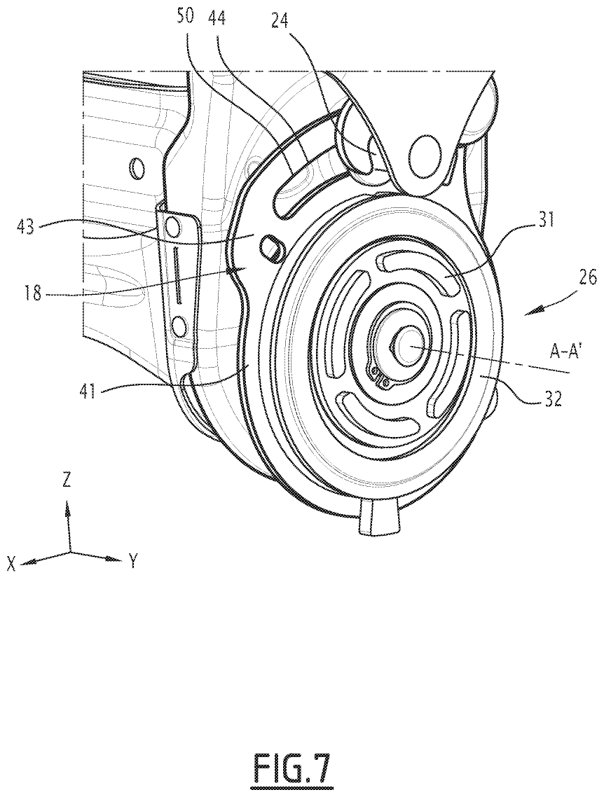

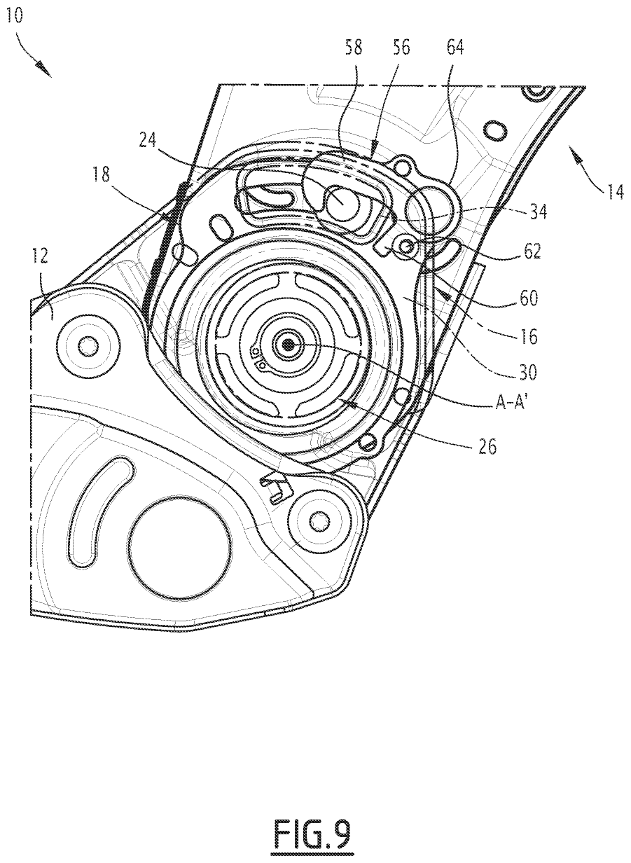

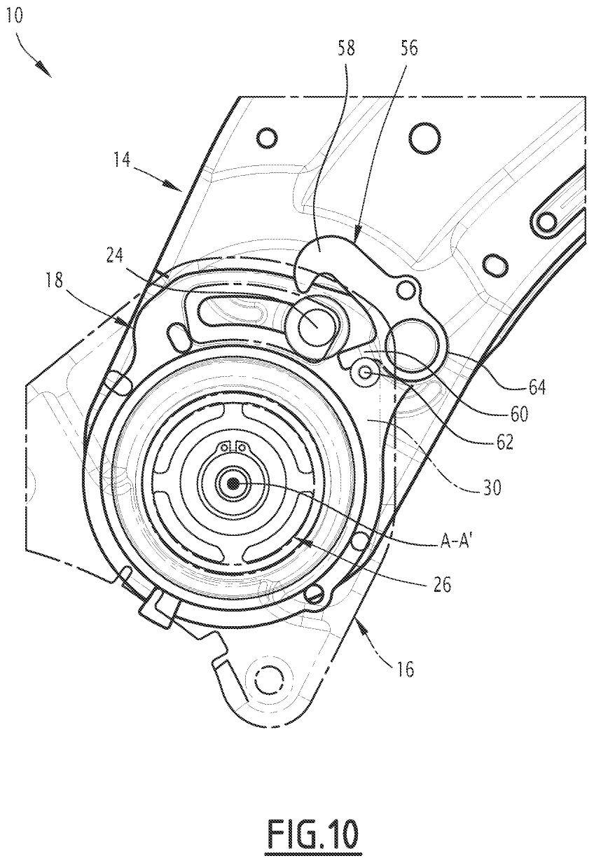

With reference to FIGS. 9 and 10, the straightening device 18 comprises a locking element 56 movable between a locking position (visible in FIG. 7) in which it prevents movement of the pin 24 in the straightening slot 44 and an unlocking position (visible in FIG. 8) in which it permits movement of the pin 24 in the straightening slot 44.

The locking element is connected to the body 41 of the straightening device 18. In particular, the locking element is connected to the extension 43 of the body 41.

The locking element comprises a hook 58, a lever arm 60 and a return element 64.

The hook 58 is rotatably mounted on the body 41 about an axis of rotation parallel to the axis A-A′ between a hooking position visible in FIG. 9 in which the hook 58 hooks the pin 24 and a release position visible in FIG. 10 in which the hook 58 is away from the pin 24.

In the hooking position, which corresponds to the locking position of the locking element 56, the hook 58 holds the pin 24 in the first portion 48 of the straightening slot 44 and thus prevents movement of the pin 24 toward the second portion 50.

In the release position, which corresponds to the unlocking position of the locking element 56, the hook 58 is away from the pin 24 so that it does not retain the pin 24 in the first portion 48. Thus, in the release position, the pin 24 is able to be moved into the second portion 50 of the straightening slot 44.

The lever arm 60 extends from the hook 58 and is connected to the hook 58. The lever arm 60 is intended to interact with a pivot point 62 placed on the abutment element 30. The pivot point 62 is a projection, for example, extending from the abutment element 30 toward the straightening device 18.

In the raised position of the backrest 14, the lever arm 60 is away from the pivot point 62. As the backrest 14 is rotated from its raised position to its inclined position, the lever arm 60 contacts the pivot point 62 so that the lever arm 60 engages the pivot point 62.

When the lever arm 60 engages the pivot point 62, it rotates the hook 58 on the body 41 and causes the hook 58 to move from its hooking position to its release position.

Thus, movement of the backrest 14 from the raised position to the inclined position causes the hook 58 to move from its hooking position to its release position and thus causes the locking element 56 to move from its locking position to its unlocking position.

Thus, the locking element 56 enables the movement of the pin 24 in the second portion 50 of the straightening slot 44 when the backrest 14 is in an inclined position in which the backrest 14 forms an angle β with the elevation direction Z greater than a threshold angle. This threshold angle corresponds to the angle that the backrest 14 forms with the elevation direction when the locking element 56 moves from its hooking position to its release position.

The return element 64 is a return element for the hook 58. The return element 64 is attached to the straightening device 16 and is arranged to cause the hook 58 to move to its hooking position when the backrest 14 is moved to its raised position.

The return element 64 is thus configured to apply a return torque to the hook 58.

The return element 64 is, for example, as illustrated in FIGS. 9 and 10 a torsion spring.

The operation of the seat 10 is described in the following.

Under normal use conditions of the seat 10, when a user wishes to move the backrest 14 between an inclined position and a raised position, the user uses the control element to switch the hinge mechanism to its first configuration.

The user then rotates the backrest 14. The pin 24 of the backrest 14 is then driven into the slideway 34 while remaining blocked in the first portion 48 of the straightening slot 44 by the bridge 52.

The pin 24 moves between a position in which it abuts the first front end 36 in the raised position of the backrest 14 and a position in which it is spaced from the first front end 36 in an inclined position. In the extreme inclined position of the backrest 14, the pin abuts against the first rear end 38.

When the user is satisfied with the position of the backrest 14, the user uses the control element to shift the hinge mechanism to its second configuration.

If the backrest 14 is in an inclined position so that the locking element 56 is in its unlocking position, the pin 24 is away from the first front end 36 of the slideway 34.

When the backrest 14 is in this inclined position and when an impact torque greater than a predetermined torque is applied to the backrest 14 particularly in the event of an impact to the vehicle, the backrest 14 and consequently the pin 24 are driven forward. The pin 24 then breaches the bridge 52, which allows the backrest 14 to rotate freely with respect to the straightening device 18 and the second flange 32, from the inclined position to the raised position.

The pin 24 then moves into the straightening slot 44 under the force of the impact from a rear end of the straightening slot 44 to the first front end 36 of the slideway 34.

The pin 24 then deforms the dissipation portion of the second portion 50 of the straightening slot 44 which at least partially dissipates the impact energy resulting from the impact force due to the shock.

The backrest 14 is then in a raised position, in particular in the extreme raised position.

The occupant is then placed in an upright position on the seat 10 in which the risk of injury from the impact is reduced.

The invention as described thus makes it possible to provide a vehicle seat 10 that reduces the risks incurred by the occupant, in particular when the occupant is in an inclined position in the seat 10 in an accident involving, for example, a frontal impact. The seat 10 ensures that the backrest 14 of the seat 10 is upright during such an impact, so that the body of the user of the seat is properly supported by the occupant protection devices such as the seat belt or airbags. Such a seat 10 thus prevents impact energy from being dissipated through organs of the user such as, for example, the occupant's ribs which are particularly vulnerable when the backrest is in an inclined position.

1. A vehicle seat comprising:
a cushion,
a backrest,
an articulation comprising a first flange fixed to the cushion and a second flange fixed to the backrest, the second flange being mounted rotatable about an axis with respect to the first flange via a hinge mechanism,
the hinge mechanism being movable between a first configuration in which it enables the backrest to be unlocked and/or rotated relative to the cushion and a second configuration in which it allows the backrest to be blocked relative to the cushion,
the hinge mechanism being movable between the first and second configurations via a control element actuatable by an occupant of the seat,
a straightening device for straightening the backrest interdependently rotating with the second flange, the straightening device defining a straightening slot, the straightening slot comprising a first portion separated from a second portion by a bridge, and
a pin integral with the backrest, the pin extending into the first portion of the straightening slot and being disposed in contact with the edges of the first portion and the bridge, such that, under normal use conditions, the pin ensures the attachment between the backrest and the second flange via the straightening device, the rotation of the second flange about the axis going hand in hand with the rotation of the backrest,
the seat being such that, when the locking mechanism is in its second configuration and when an impact torque greater than a predetermined torque is applied to the backrest, the pin breaches the bridge and then moves freely in the second portion of the straightening slot, which makes the rotation of the backrest free with respect to the straightening device and the second flange.

2. The seat according to claim 1, wherein when the locking mechanism is in its second configuration and when an impact torque greater than a predetermined torque is applied to the backrest, this makes the rotation of the backrest about the axis relatively to the second flange free.

3. The seat according to claim 1, wherein the backrest is rotatable with respect to the cushion about the axis between a raised position in which the seat is able to receive a seated occupant in an upright position, and at least one inclined position, in which the seat is able to receive an occupant in a semi-recumbent or recumbent position the backrest forming a first angle with an elevation direction in the raised position and the backrest forming a second angle with the elevation direction in the inclined position, the second angle being greater than the first angle.

4. The seat according to claim 3, wherein the hinge mechanism comprises a blocking element movable between a blocking position in which the second flange is rotationally blocked and a unblocking position in which the second flange is rotatable about the axis,
the seat being such that, under normal conditions of use of the seat, when the blocking element is in its unblocking position, the rotation of the second flange about the axis causes the rotation of the straightening device which causes the movement of the pin so that the backrest is moved between the raised position and the inclined position,
the seat further being such that when an impact torque greater than a predetermined torque is applied to the backrest, and when the blocking element is in its blocking position, the pin breaches the bridge and then moves freely into the second portion of the straightening slot, causing the backrest to move relative to the straightening device from the inclined position to the raised position.

5. The seat according to claim 3, further comprising an abutment element connected to the cushion and defining a slideway, the straightening slot extending at least partially opposite the slideway, the pin further extending into the slideway and moving in the slideway when the backrest is moved between its raised position and its inclined position.

6. The seat according to claim 5, wherein the slideway extends between a first front end and a first rear end, the pin abutting said first front end in an extreme raised position and the first rear end in an extreme inclined position.

7. The seat according to claim 6, wherein when the locking mechanism is in its second configuration and an impact torque is applied to the backrest, the pin moves in the straightening slot from a second rear end of the straightening slot to the first front end of the slideway.

8. The seat according to claim 5, wherein the slideway and the straightening slot extend along an arc of a circle having the axis as its center.

9. The seat according to claim 5, wherein the slideway limits the movement of the pin of the backrest during rotation of the backrest relative to the cushion.

10. The seat according to claim 1, further comprising an actuator for actuating the second flange, the actuator driving the second flange substantially in rotation about the axis relatively to the first flange.

11. The seat according to claim 1, wherein the straightening slot comprises a dissipation portion, the width of the dissipation portion being less than a dimension of the pin, the width of the dissipation portion and the dimension of the pin being taken in the direction perpendicular to the direction of movement of the pin in the straightening slot,
the pin expanding the width of the dissipation portion as it moves through the straightening slot.

12. The seat according to claim 1, wherein the straightening device comprises a body, the body interdependently rotating with the second flange and defining the straightening slot of the straightening device, the bridge being integral with the body.

13. The seat according to claim 1, wherein the pin is blocked between the bridge and an end of the straightening slot under normal use conditions of the seat.

14. The seat according to claim 13, wherein the first portion of the straightening slot fits the shape of the section of the pin extending into the straightening slot.

15. The seat according to claim 1, wherein the straightening device is made in a single piece with the second flange.
